(19) United States
(12) Patent Application Publication
(10) Pub. No.: US 2003/0070308 A1
(43) Pub. Date: Apr. 17, 2003

(54) Chain saw

(75) Inventors: Hisato Ohsawa, Fussa-shi (JP); Hiroaki Koga, Sayama-shi (JP); Masato Nara, Nishitokyo-shi (JP)

Correspondence Address: NIXON PEABODY, LLP, 8180 GREENSBORO DRIVE, SUITE 800, MCLEAN, VA, 22102, US

(73) Assignee: KIORITZ CORPORATION, Tokyo (JP)

(21) Appl. No.: 10/269,077

(22) Filed: Oct. 11, 2002

(30) Foreign Application Priority Data
Oct. 15, 2001 (JP) 2001-317040

(51) Int. Cl. B27B 17/00

(52) U.S. Cl. 30/381; 30/296.1

(57) ABSTRACT

The present invention provides a chain saw having a high degree of safety for its various positions including an upward and a downward position. The chain saw comprises a bar-shaped top handle extending in a lengthwise direction above an upper surface of a main body and a bar-shaped side handle provided next to a left side surface of the main body. When the main body is seen in a plan view, a front end portion of the side handle is intersected transversely with and coupled to a left side surface of a front end portion of the top handle. A right-side support surface extending outwardly in the transverse direction is provided on a right side surface of the front end portion of the top handle. It is located substantially at the same position as a left-side support surface which is comprised of a rear surface of the front end portion of the side handle in the lengthwise direction of the main body.

### FIELD OF THE INVENTION

The present invention relates to a chain saw driven by an internal combustion engine or the like.

### BACKGROUND OF THE INVENTION

There has been known a chain saw which is driven by an air-cooled two-stroke internal combustion engine to cut a trunk and/or branches of a tree. Among these chain saws, the one generally referred to as a top-handle saw is used to trim overhead branches and the like. It is formed lightweight and compact so as to faciliate to lift it up even by one hand. A typical one of above-mentioned top-handle saws has a bar-shaped top handle extending in a lengthwise direction above the upper surface of a main body that accommodates an internal combustion engine as a driving source, and a bar-shaped side handle provided next to a left side surface of the main body. An operator grips the top handle with a right hand and the side handle with a left hand to trim tree trunks, branches, and leaves.

While carrying out a tree-trimming work, the operator needs to change the directions. In particular, when the operator trims the branches and leaves over or below the operator's head, the saw must be used in an upward or downward position in which a chain bar of the chain saw is oriented in a vertical direction. In some cases, the operator may have to grip the top handle of the chain saw with the right hand and support the chain saw only one hand. The chain saw must ensure safety of the operator regardless of the positions of the chain saw.

Therefore, it is an object of the present invention to provide a chain saw having a high degree of safety in its various positions including the upward or downward position.

### SUMMARY OF THE INVENTION

The above-mentioned object can be achieved by a chain saw which comprises a bar-shaped top handle extending in a lengthwise direction above an upper surface of a main body and a bar-shaped side handle provided next to a left side surface of the main body. When the main body is seen in a plan view, a front end portion of the side handle is transversely intersected with and coupled to a left side surface of a front portion of the top handle. A right-side support surface extending outwardly in the transverse direction is provided on a right side surface of the front portion of the top handle. The right-side support surface is located substantially at the same position in the lengthwise direction of the main body as a left-side support surface which is a rear surface of the front end portion of the side handle.

According to the present invention, when an operator grips the top handle with one hand and works with the chain saw in its upward position, the entire weight of the chain saw is supported at the left-side support surface and the right-side support surface. Therefore, the operator can hold the chain saw firmly and stably by one hand without the chain saw being swung side to side, whereby further safety can be assured. Furthermore, since the chan saw is supported at the left-side and right-side support surfaces, the hand that grips the top handle does not slip toward a chain bar beyond the left-side and right-side support surfaces despite of the downward force given due to the weight of the chain saw. Therefore, the operator's fingers do not accidentally touch a chain situated in front thereof, whereby safety of the operator is assured.

In an embodiment of the present invention, the left-side support surface and the right-side support surface, which extend outwardly in the left and right directions, respectively, with respect to the top handle, are formed in a concave-shape toward the back so as to form substantially complementary shapes to the thumb's base portion and the index finger's base portion, respectively, of the operator's right hand which grips the top handle.

Further, in the embodiment of the present invention, the right-side support surface extends downward from the right-hand side of the top handle.

Further, in another embodiment of the present invention, an anti-slip portion is provided on an upper surface of a rear portion of the top handle to prevent the operator's right hand from slipping backward.

Moreover, in still another embodiment of the present invention, the anti-slip portion is comprised of a protruding portion which projects upwardly at the backward of the right hand that grips the top handle.

According to the present invention, the chain saw having a high degree of safety for its various positions including an upward and downward positions can be provided.

Other features and advantages of the present invention will be apparent from the accompanying drawings and from the detailed description.

### BRIEF DESCRIPTION OF THE DRAWINGS

FIG. 1 is a plan view of a main body of a chain saw according to an embodiment of the present invention;

FIG. 2 is a rear view of the main body of the chain saw according to the embodiment of the present invention;

FIG. 3 is a right side view of the main body of the chain saw according to the embodiment of the present invention; and

FIG. 4 illustrates an example of a variation of the embodiments shown in FIGS. 1-3.

### DESCRIPTION OF THE PREFERRED EMBODIMENTS

Embodiments of a chain saw according to the present invention will now be described with reference to the accompanying drawings.

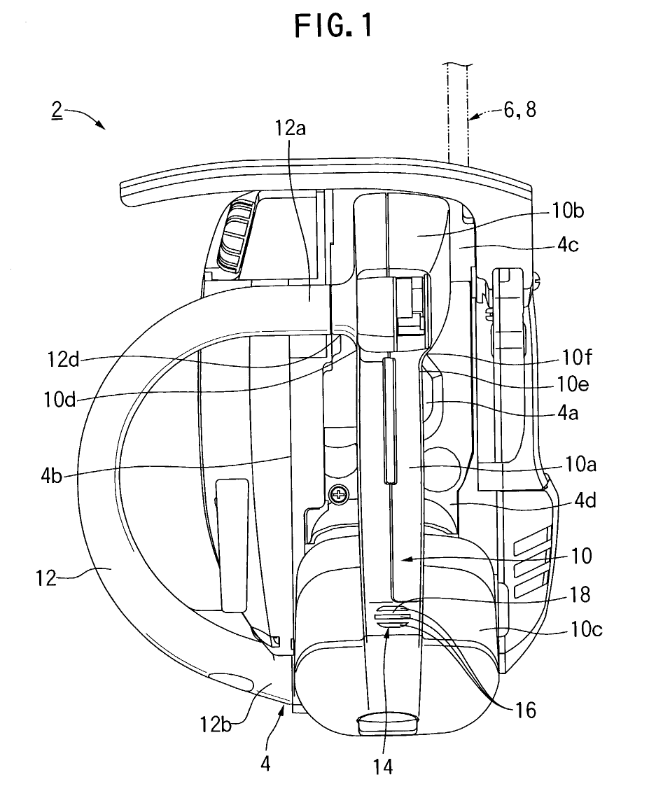

As shown in FIG. 1, the chain saw 2 has a main body 4 that is located at the back thereof and accommodates an internal combustion engine such as a compact air-cooled two-stroke gasoline engine or the like as a driving source, a chain guide bar 6 extending straight in a forward direction from a front end portion at the right-hand side of the main body 4, and a saw chain 8 running along a guide formed on a periphery of the chain guide bar 6. The chain guide bar 6 and the saw chain 8 are shown in double-dot chained lines in each figure.

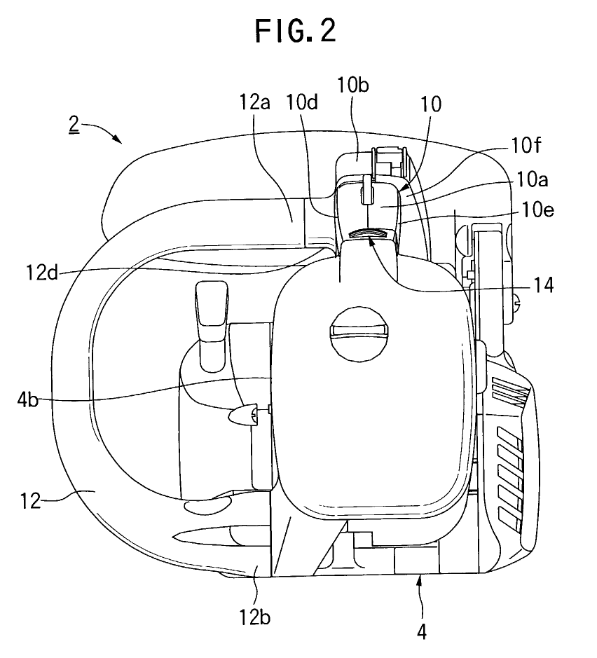

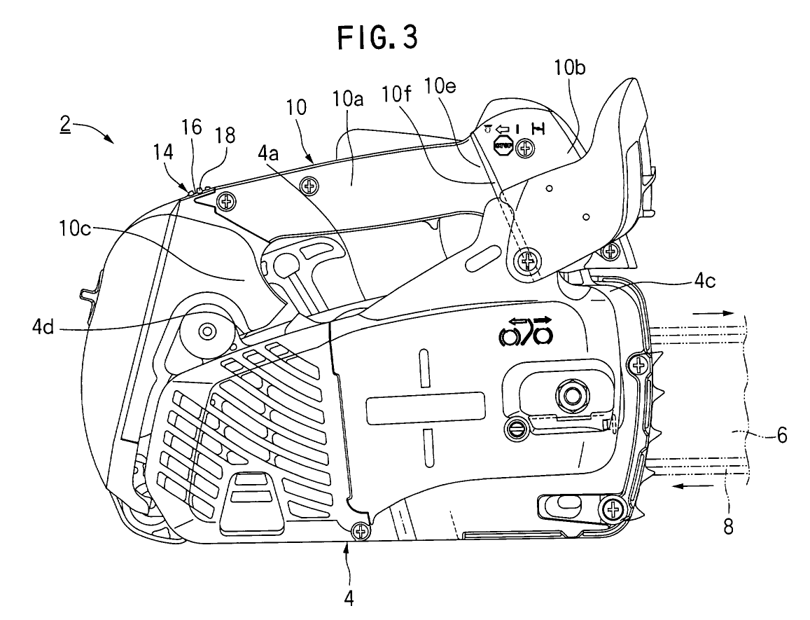

As can be seen from FIGS. 1-3, the main body 4 has a bar-shaped top handle 10 extending in a lengthwise direction above an upper surface 4a thereof and a bar-shaped side handle 12 provided next to a left surface 4b thereof. More specifically, as best described in FIG. 3, the top handle 10 has a grip portion 10a extending lengthwise for an operator to grip with the right hand, a front end portion 10b extending downwardly from a front end of the grip portion 10a toward a front portion 4c of the upper surface 4a of the main body 4, and a rear end portion 10c extending downwardly from a rear end of the grip portion 10a toward a rear portion 4d of the upper surface 4a, and forms an arch shape as a whole.

When the main body 4 is seen in a plan view as shown in FIG. 1, a front end portion 12a of the side handle 12 is intersected transversely with and coupled to a left side surface 10d of the front portion of the top handle 10. A rear portion 12b of the side handle 12 extends transversely to a lower rear corner on the left side surface 4b of the main body 4 and it is coupled thereto to form a C-shape as a whole. A rear surface of the front end portion 12a of the side handle 12, that is, a surface adjacent to the front end portion 10b of the top handle 10 comprises a left-side support surface 12d against which a base portion of a thumb of the right hand that grips the top handle 10 abuts. Further, on a right side surface 10e of the front end portion 10b of the top handle 10 is provided with a right-side support surface 10f extending outwardly in the transverse direction substantially at the same position as the left-side support surface 12d which is comprised of a rear surface of the front end portion 12a of the side handle 12 in the lengthwise direction of the main body 4. The base portion of an index finger of the right hand is supported by the right-side support surface 10f.

As best described in FIG. 1, the left-side support surface 12d and the right-side support surface 10f extending outwardly in the left and right directions, respectively, with respect to the top handle 10 are formed in a concave-shape toward the back to form shapes complementary to the thumb's base portion and the index finger's base portion respectively of the operator's right hand which grips the top handle 10. Further, as shown in FIG. 3, the right-side support surface 10f extends downwardly across the front-end portion 10b from the right side of the top handle 10 to the lower end of the front-end portion 10b of the top handle 10. In FIG. 3, the lower portion of the right-side support surface 10f is shown in dotted lines.

As shown in FIGS. 1-3, on the upper surface of the rear portion of the top handle 10 is provided with an anti-slip portion 14 to prevent the operator's right hand from slipping backward. More specifically, the anti-slip portion 14 is provided at the back of the grip portion 10a, that is, on an upper portion of the rear end portion 10c of the top handle 10. The anti-slip portion 14 is comprised of a protruding portion 18 projecting upward from an upper surface of the top handle 10. A plurality of first grooves 16 extending transversely with respect to the longitudinal direction of the top handle 10 are formed in the protruding portion 18 in order to enhance the anti-slip effect.

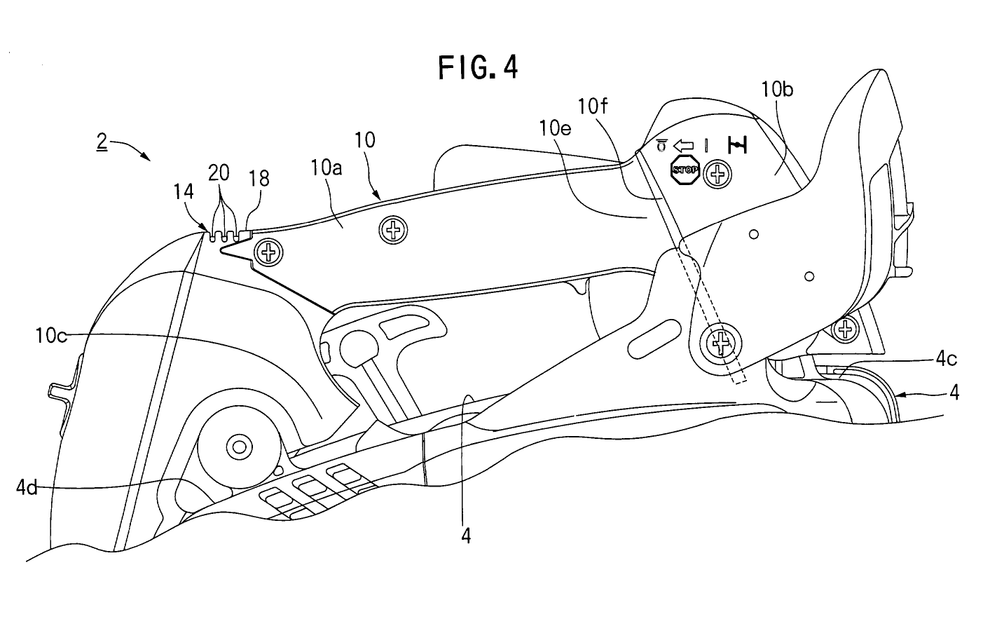

In an embodiment shown in FIG. 4, only the anti-slip portion 14 is different from the embodiment shown in FIGS. 1-3, and the other parts are the same. Therefore, the same reference numerals are used to denote the same parts and the description therefor is omitted. Only the anti-slip portion 14 will be described below.

In the anti-slip portion 14 shown in FIG. 4, the protruding portion 18 is comprised of a rear end portion 10c of the top handle 10 which is bulged upwardly from the grip portion 10a. More specifically, the grip portion 10a of the top handle 10 is inclined downwardly toward the back in the lengthwise direction. The protruding portion 18 is comprised of the rear end portion 10c of the top handle 10 which is inclined slightly upwardly toward the back from the rear end of the of the grip portion 10a. A plurality of second grooves 20 are formed on the protruding portion 18 in the transverse direction with respect to the longitudinal direction of the top handle 10.

The operation of the chain saw shown in FIGS. 1-4 will now be described here-below. The operations of the embodiments shown in FIGS. 1-3 and the variation shown in FIG. 4 are the same.

In a typical working position in which the chain guide bar 6 extends forwardly from the operator, the operator grips the top handle 10 with the right hand and the side handle 12 with the left hand. In this position, four fingers but the thumb of the right hand are located at the right-hand side of the top handle 10 wherein the right-side support surface 10f serves as a protection wall that shields between the fingers and the chain guide bar 6 to prevent the fingers from approaching the saw chain 8.

Further, the operator may trim overhead branches and leaves with the chain saw 2 in the upper position in which the chain guide bar 6 is directed upwardly. In trimming the branches in this upward position, the operator may have to grip the top handle 10 of the chain saw 2 with the right hand and hold the chain saw 2 by one hand. In this case, the entire weight of the chain saw 2 is supported at the left-side support surface 12d and the right-side support surface 10f.

Further, in the upward position, a downward force due to the load of the chain saw 2 is exerted on the right hand holding the top handle 10, and the right hand is moved forward in the lengthwise direction of the chain saw 2 along the top handle 10. However, the left-side support surface 12d and the right-side support surface 10f serve as a stopper for the right hand to prevent the right hand from approaching to the chain guide bar 6.

Further, the operator may trim the branches and/or leaves in a downward posture by the chain guide bar 6 of the chain saw 2 directed downwardly. In trimming the branches in this position, the operator may have to grip the top handle 10 of the chain saw 2 with the right hand and hold the chain saw 2 by one hand. In this case, a downward force due to the weight of the chain saw 2 is exerted on the right hand holding the top handle 10, and the right hand is moved backward in the longitudinal direction of the chain saw 2 along the top handle 10. However, whereas the protruding portion 18 serves as the stopper to prevent the chain saw 2 from slipping out of the right hand due to the weight of the chain saw 2.

According to the chain saw 2 shown in FIGS. 1-4, the right-side support surface 10f extends downwardly from the right side of the top handle 10. More specifically, it extends across the front end portion 10b of the top handle 10. Since it serves as the protection wall to protect the fingers from touching the chain guide bar 6, the fingers can be protected from accidentally contacting with the saw chain 8. Thus, the chain saw with improved safety can be provided.

Further, the left-side support surface 12d and the right-side support surface 10f extending outwardly in the left and right directions, respectively, with respect to the top handle 10 are formed in a concave-shape toward the back so as to form substantially complementary shapes to the thumb's base portion and the index finger's base portion, respectively, of the operator's right hand which grip the top handle 10. Thus, since the operator can grip the top handle 10 firmly, the safety can be further assured.

Further, since the anti-slip portion 14 is provided on the upper surface of the rear end portion 10c of the top handle 10 to prevent the operator's right hand from slipping backward, the operator can grip the top handle 10 firmly even if the chain saw 2 is in the downward position, whereby the safety of the operator is assured.

Moreover, since the anti-slip portion 14 is comprised of the protruding portion 18 which projects upwardly at the back of the right hand that grips the top handle 10. Therefore, the right hand hardly slips backwardly with respect to the grip portion 10a. As the grooves 16,20 are also formed on the protruding portion 18 to increase frictional, the slipping is prevented more reliably.

It is to be understood that the present invention is not limited to the above-mentioned embodiments and, without departing from the scope of the invention defined in the attached claims, a variety of modifications can be made that fall into the scope of the invention.

In the present embodiments, the anti-slip portion 14 is comprised of the protruding portion 18 such that the right hand will not slip over it. In addition, a frictional portion such as using a rubber material may be provided on the anti-slip portion 14, thereby preventing the right hand from slipping in the backward direction.

Further, it will be apparent that the present invention can be applied to a chain saw using an electric motor as a power source.

What is claimed is:

1. A chain saw, comprising:
a bar-shaped top handle extending in a lengthwise direction above an upper surface of a main body; and
a bar-shaped side handle provided next to a left side surface of said main body, wherein a front end portion of said side handle is transversely intersected with and coupled to a left side surface of a front end portion of said top handle when said main body is seen in a plan view;
a right-side support surface extending outwardly in the transverse direction being provided on a right side surface of said front end portion of said top handle when said main body is seen in the plan view; and
a left-side support surface being located on a rear surface of said front end portion of said side handle in the lengthwise direction of said main body and being located at substantially at the same position as said right-side support surface.

2. The chain saw according to claim 1, wherein said left-side and said right-side support surfaces extending outwardly in the left and right directions, respectively, with respect to said top handle are formed in a concave-shape toward the back to form complementary shapes to the thumb's base portion and the index finger's base portion, respectively, of an operator's right hand which grips said top handle.

3. The chain saw according to claim 1 or 2, wherein said right-side support surface extends downward from the right-hand side of said top handle.

4. The chain saw according to any one of claims 1 or 2, wherein an anti-slip portion is provided on an upper surface of a rear portion of said top handle to prevent the operator's right hand from slipping backwardly.

5. The chain saw according to claim 1 or 2, wherein an anti-slip portion is provided on an upper surface of a rear portion of said top handle to prevent the operator's right hand from slipping backwardly, and said anti-slip portion projects upwardly at the back of the right hand that grips said top handle.
